(19) United States
(12) Patent Application Publication
(10) Pub. No.: US 2003/0074383 A1
(43) Pub. Date: Apr. 17, 2003

(54) Shared multiplication in signal processing transforms

(76) Inventor: Charles Douglas Murphy, Chicago, IL (US)

Correspondence Address: CHARLES DOUGLAS MURPHY, 601 LINDEN PLACE #210, EVANSTON, IL, 60202, US

(21) Appl. No.: 09/976,920

(22) Filed: Oct. 15, 2001

(51) Int. Cl. G06F 7/52

(52) U.S. Cl. 708/620

(57) ABSTRACT

A machine or method used in signal processing transforms involving computation of one or more sums each of one or more products. A first multiplier computes a first product and a first set of intermediate terms. A second multiplier computes a second product using one or more of the terms computed by the first multiplier. Because they share computations, the two multipliers can have lower implementation cost than if they function separately. The invention is particularly useful in signal processing transforms that have fixed weights, such as discrete Fourier transforms, discrete cosine transforms, and pulse-shaping filters. These transforms are multiply-intensive and are used repeatedly in many applications. Implementations of shared multiplication techniques can have reduced chip space, computation time, and power consumption relative to implementations that do not share computation. Depending on the properties of the transform being computed, shared multiplication can exploit constant numbers, variable numbers from limited sets of allowed values, and restrictions on one or both numbers in particular products.

### STATEMENT REGARDING FEDERALLY SPONSORED RESEARCH OR DEVELOPMENT

Not applicable

### REFERENCE TO A MICROFICHE APPENDIX

Not applicable

### BACKGROUND

1. Field of Invention

The invention relates to number transforms used in signal processing, specifically to sharing computation when calculating products for transforms that use sums of products.

2. Description of Prior Art

Signal processing involves manipulation of one or more input signals in order to produce one or more output signals. In digital signal processing, the signals are represented by numbers. The numbers have finite-precision representations in particular formats such as binary twos complement, signed integer, unsigned integer, and floating point, among others.

Arithmetic operations are basic tools of digital signal processing. Two of the most important arithmetic operations are multiplication and addition. While these two operations can be used to compute a wide variety of mathematical functions, a very important class of signal processing transforms consists of transforms that compute sums of products. Important examples of such transforms are discrete Fourier transforms, discrete cosine transforms, discrete sine transforms, and corresponding inverse transforms for each. Typically, these transforms accept a set of inputs, multiply the inputs by sets of weights, and add the resulting products to produce a set of outputs. In these transforms, addition and multiplication operations are used repeatedly, and sometimes exclusively.

Computational complexity is an important issue in practical applications of signal processing transforms. For signal processing transforms that make extensive use of multiplication and addition operations, the computational complexity may be measured by the total number of multiplication operations, the total number of addition operations, or both. Ultimately, each arithmetic operation has a cost measured in terms of chip space, power consumption, processor cycles, or some other resource.

In some important technologies, such as application-specific integrated circuits, field-programmable gate arrays, and general purpose microprocessors, a multiplication operation may be much more expensive than an addition operation, so that the multiplication count dominates the computational complexity. It is particularly desirable when using such technologies to reduce the number of multiplication operations, to reduce the cost of multiplication operations, or to reduce both.

A general multiplier is a circuit or sequence of operations that is able to compute the product of two numbers. It is possible that the two numbers take on any value permitted by their respective finite-precision numeric formats. Since it can accept any pair of input numbers, a general multiplier is very flexible and can be re-used within an application or in different applications. However, it may be very costly to implement.

A constant multiplier is a circuit or sequence of operations that is able to multiply a number by a constant. The number may take on any value allowed by its finite-precision numeric format. Since the constant does not change, one can design and use a constant multiplier which has much lower cost than a corresponding general multiplier. The price for the reduced cost is that the constant multiplier is not as flexible as a general multiplier. However, if one of the numbers being multiplied is known in advance, a dedicated constant multiplier can lead to low-cost transform implementations.

Constant multipliers and techniques for designing constant multipliers appear in U.S. Pat. No. 6,223,197 (issued to K. Kosugi on Apr. 24, 2001), in U.S. Pat. No. 5,903,470 (issued to A. Miyoshi and T. Nishiyama on May 11, 1999), in U.S. Pat. No. 5,841,684 (issued to K. Dockser on Nov. 24, 1998), in U.S. Pat. No. 5,815,422 (issued to K. Dockser on Sep. 29, 1998), in U.S. Pat. No. 5,600,569 (issued to T. Nishiyama and S. Tsubata on Feb. 4, 1997) and in U.S. Pat. No. 5,159,567 (issued to J. Gobert on Oct. 27, 1992).

Another technique aimed at reducing the cost of a multiplication operation in signal processing transforms appears in the patent application NON-CONSTANT REDUCED-COMPLEXITY MULTIPLICATION IN SIGNAL PROCESSING TRANSFORMS by the inventor of the present invention. A non-constant, non-general multiplier is proposed. At least one of the numbers to be multiplied is not a constant and is also not allowed to take on any value permitted by its finite-precision numeric format. A non-constant, non-general multiplier can exploit restrictions on one or both numbers being multiplied to achieve greater flexibility than a constant multiplier at lower cost than a general multiplier.

It has long been recognized that there are a number of low-cost multiplication operations. For instance, multiplication by 1 has zero cost. In signed binary representations, multiplication by −1 can be as simple as flipping a sign bit. In binary twos complement representations, multiplication by −1 can be accomplished by flipping bits in a number representation and adding a constant number value.

Another low-cost multiplication operation in binary representations with power-of-two element values is shifting. Shifting a number represented in such a format implements multiplication by a power of two, such as multiplication by 2, by 4, or by 8, or multiplication by ½, by ¼, or by ⅛.

Constant multipliers, non-constant, non-general multipliers, and low-cost multiplication techniques have been proposed for used in reducing the implementation cost of signal processing transforms such as the discrete Fourier transform, the discrete cosine transform, and the discrete sine transform, where transform weights are known constants. These techniques do not reduce the cost as measured by the number of multiplication operations. The do reduce the cost of individual multiplication operations. The cost reductions depend on exploiting special properties of the number values used in the transform, special properties of the finite-precision numeric formats in which those number values are represented, or special properties of the representations of the number values.

Fast Fourier transform techniques for computing discrete Fourier transforms have managed to reduce the complexity of these transforms from on the order of N² multiplication operations to on the order of N log N operations, where N is the transform size and the logarithm is of base 2. The order N² complexity is obtained from direct computation of a common closed-form expression of discrete Fourier transforms, and represents N inputs each multiplied by N weights, with the resulting products added to produce N outputs.

The order N log N complexity depends on special properties of discrete Fourier transform weights and lowest complexity is obtained for particular N values that are highly composite. A highly composite N value is one that can be factored into the product of very small integer factors. In most fast Fourier transform techniques, a large-sized transform is decomposed into a set of smaller-sized transforms. It may be possible to recursively decompose the smaller-sized transforms to the level of very small integer factors.

At the lowest level of recursive decomposition, the transforms may be able to exploit some of the low-cost multiplication operations discussed above, as well as low-cost complex operations such as multiplication by purely real or purely imaginary numbers.

The weights in discrete Fourier transforms are complex numbers uniformly spaced on a unit circle in the complex plane. One of the weights is on the positive real axis. In a Cartesian complex coordinate system, discrete Fourier transform weights allow repeated application of the distributive property of multiplication. Fast Fourier transform techniques take advantage of this to compute discrete Fourier transforms using a sequence of computation stages. Each stage produces outputs that are weighted inputs. Intermediate stages compute intermediate outputs which contain non-zero net weighting of more than one transform input. Each intermediate output is passed to more than one input of the next stage.

Part of the multiplication complexity reduction of fast Fourier transform techniques and fast techniques for other transforms such as discrete cosine transform and discrete sine transforms is a result of shared computation of the products which appear in the closed-form direct expressions of the transforms. This complexity reduction depends on properties of the number values and on computation in Cartesian coordinates. This complexity reduction does not depend on special properties of the representations of the number values and also does not depend on special properties of particular finite-precision numeric formats.

Another example of shared multiplication complexity is embodied by an extension of the complex multiplier of U.S. Pat. No. 4,354,249 issued to T. M. King and S. M. Daniel on Oct. 12, 1982. The complex multiplier is capable of computing the product of a first complex number and a second complex number, or of computing the product of the first complex number and the complex conjugate of the second complex number. A control signal determines which result the multiplier produces. The multiplier could be modified to provide both products, in which case the computation of one product could use the values computed for the other.

As with the multiplication complexity reduction due to decomposition in fast Fourier transforms, the complexity reduction of the extension of the multiplier in U.S. Pat. No. 4,354,249 suggested above depends on the properties of complex number values in Cartesian coordinates. The complexity reduction also depends on a special relationship between the output products. The complexity reduction does not depend on special properties of finite-precision numeric formats or on special properties of number representations in particular finite-precision numeric formats.

Signal processing transforms such as discrete Fourier transforms, inverse discrete Fourier transforms, and other transforms that compute sums of products are widely used in areas such as digital communications and sonar, radar, speech, image, biomedical, and video signal processing. Whether or not a particular transform is or is not practical depends in large part on the economic cost of building a device to compute the transform and on technological limitations. Many transforms rely heavily on the basic operation of multiplication for signal manipulation. Techniques for low-complexity multiplication and for reducing the number of required multiplication operations are very useful in enabling practical signal processing systems.

The disadvantages of prior art multipliers used in signal processing transforms and of prior art fast techniques for certain transforms are the following:

a. A general multiplier which can compute any of the desired products in a signal processing transform and also other products may be very costly to implement, particularly in technologies such as application-specific integrated circuits, field-programmable gate arrays, and general purpose microprocessors.

b. A constant multiplier which can compute any of the desired products in which one of the numbers is equal to a known constant may have very low individual cost, but also very low flexibility, so that many different constant multipliers may be required for a particular signal processing transform.

c. Prior art non-constant, non-general multipliers have greater flexibility but greater cost than constant multipliers, and at the same time have lower cost and lower flexibility than general multipliers, yet still compute one product at a time separately from other product computations.

d. Using constant multipliers, existing low-cost multiplication operations for special number values and representation formats, or non-constant, non-general multipliers in a signal processing transform reduces the complexity of multiplication operations, but not the number of multiplication operations.

e. Prior art techniques for fast computation of discrete Fourier transforms and other transforms exploit special relationships among the number values of the transform weights when computing in Cartesian or real coordinate systems, but do not exploit special relationships among the particular representations of those number values in particular finite-precision numeric formats.

f. Prior art techniques for multipliers that can produce multiple outputs exploit special relationships between the desired outputs when computing in Cartesian or real coordinate systems, but do not exploit special relationships among the particular representations of the multiplier inputs in particular finite-precision numeric formats.

### SUMMARY

The present invention is a technique used in signal processing transforms that compute sums of products, involving multipliers that share intermediate computation results.

Objects and Advantages

Accordingly, several objects and advantages of the present invention are that:

a. Using said invention, computation of two or more products together can be accomplished with lower cost than if each product were computed separately.

b. Said invention can be applied to general multipliers, to constant multipliers, to non-constant, non-general multipliers, or to combinations of multipliers, resulting in a reduction in the overall cost of computing a signal processing transform.

c. Said invention can be applied to signal processing transforms with fixed, known weights, such as discrete Fourier transforms, discrete cosine transforms, discrete sine transforms, and inverse transforms corresponding to each of these, resulting in reduced computational cost.

d. Said invention can be applied to fast transform techniques such as fast Fourier transforms, fast cosine transforms, fast sine transforms, and fast inverse transforms corresponding to each of these, resulting in reduced computational cost.

e. Said invention can exploit the properties of finite-precision numeric representations of numbers, as well as properties that depend on the number values and not on representations in particular formats.

Further objects and advantages of the invention will become apparent from a consideration of the drawings and ensuing description.

### DRAWING FIGURES

FIG. 1 shows a structure for computing a 4-point discrete Fourier transform

FIG. 2 shows the 16-bit twos complement representations of sin(2 π/N) and sin(4 π/N)for N=64.

### REFERENCE NUMERALS IN DRAWINGS

10 a DFT input x[0]

12 a DFT input x[1]

14 a DFT input x[2]

16 a DFT input x[3]

18 a DFT output X[0]

20 a DFT output X[1]

22 a DFT output X[2]

24 a DFT output X[3]

26 a DFT weight 1+0j

28 a DFT weight 0+j

30 a DFT weight −1+0j

32 a DFT weight 0−j

34 a fifth of bit of sin(2 π/64)

36 a sixth bit of sin(2 π/64)

38 a fourth bit of sin(4 π/64)

40 a fifth bit of sin(4 π/64)

46 a desired decimal value of sin(2 π/64)

48 a desired decimal value of sin(4 π/64)

50 a fifteenth bit of sin(2 π/64)

52 a sixteenth bit of sin(2 π/64)

54 a ninth bit of sin(4 π/64)

56 a tenth bit of sin(4 π/64)

58 an eleventh bit of sin(4 π/64)

60 a twelfth bit of sin(4 π/64)

62 a 16-bit decimal value of sin(2 π/64)

64 a 16-bit decimal value of sin(2 π/64)

### Description—Signal Processing Transforms

Signal processing is widely used in such areas as digital communications, radar, sonar, astronomy, geology, control systems, image processing, and video processing. In digital signal processing, the signals are represented by numbers. Input signals or numbers are manipulated by signal processing transforms to produce output signals or numbers. The input numbers, the output numbers, and intermediate terms take on values from finite sets. The possible values for a particular number are determined by that number's finite-precision numeric format. Additionally, there may be constraints on the allowed values of certain numbers. One example of a constraint is that in discrete Fourier transform weights are known constants. Another example from digital communications is selection of a symbol from a symbol constellation. The symbol constellation may be very small relative to the set of number values supported by the finite-precision numeric format which the symbol values use.

Arithmetic operations are important tools in signal processing. Two of the most important arithmetic operations are multiplication and addition. A general multiplier is a circuit or a sequence of operations that computes the product of two numbers, each of which can have any value allowed by its finite-precision numeric format. A general adder is a circuit or sequence of operations that computes the sum of two numbers, each of which can have any value allowed by its numeric format.

General multipliers and general adders are useful in signal processing for two reasons. One is that they can be used repeatedly in a particular application or in different applications. A second reason is that there are standard circuits or operation sequences for general multipliers and general adders, so that the designer of a signal processing system does not have to build each multiplier circuit or sequence or adder circuit or sequence separately. A disadvantage of general multipliers is that they are relatively expensive to implement in technologies such as a field-programmable gate array (FPGA), an application-specific integrated circuit (ASIC), or software for a general purpose microprocessor.

Equation (1) defines a one-dimensional N-point signal processing transform that uses both multiplication operations and addition operations. The N inputs of the transform, x[n] for n=0,1, . . . ,N−1, may be real numbers or complex numbers. The N outputs, X[k] for k=0,1, . . . ,N−1, are each a sum of products. Each product is a weighted input. Each weight w[n,k] is a number that may be real or complex, depending on the transform. For an arbitrary set of weights, the computational complexity of the full transform may be as high as N² general complex multiplication operations and (N−1)² general complex addition operations. The complexity is thus on the order of N² complex operations, or O(N²) complex operations. A general complex multiplication operation is capable of computing the product of any two complex numbers. A general complex multiplier operating in Cartesian coordinates requires a minimum of three general multiplications of real numbers.

X[k]=Σ_{n=0 to N-1}x[n]w[n,k]for k=0,1, . . . ,N−1 (1)

When the weight w[n,k] is equal to exp({−j 2 πnk/N}), the transform of equation (1) is the discrete Fourier transform or DFT. When the weight w[n,k] is equal to exp({j 2 πn k/N}) the transform of equation (1) is the inverse DFT scaled by a factor N.

Signal processing transforms such as the DFT and the inverse DFT are implemented in a variety of technologies for a variety of applications. In some applications, a signal processing transform is computed repeatedly, and it is desirable to re-use circuitry or operation sequences. In real-time applications, the time available for computation is limited, so the transform should be computed quickly. Regardless of the application, there is a cost associated with the implementation. For economic and other reasons, it is useful to have low-complexity transforms and transform implementations.

### Description—Reduced-Complexity Multiplication Techniques

One way to reduce the cost of computing a signal processing transform that uses large numbers of multiplication operations is to reduce the cost of individual multiplication operations. There are many prior art examples of such techniques. Most are based on the principle of eliminating steps in the multiplication process that are not necessary or on the principle of replacing one or more necessary but high-cost steps with lower-cost but equivalent alternatives.

As a very simple example, one might “multiply” a number by 2 by adding the number to itself. A lower-cost addition operation can replace a higher-cost multiplication operation. Similarly, one might multiply a number by 3 by adding the number to itself to produce a first sum, and then adding the number to that first sum.

The procedures just above for multiplying a number by 2 and by 3 can be made even less costly, depending on the finite-precision numeric format in which the number is represented. Many binary representations have a bits which represent power-of-two numeric values. Shifting some of the bits in such representations can implement scaling by power-of-two factors. For instance, shifting bits one place can implement scaling by a factor of 2, or by a factor of ½, depending on the format and the direction of the shift.

One may be able multiply a number by 2 by shifting bits in that number's representation in a suitable finite-precision numeric format. This shifting might involve physical movement of bit values from one storage element in a storage unit to another element in the same storage unit, which could be a low-cost operations. Alternatively, it might involve a circuit design in which storage elements in one storage unit are wired to storage elements in a storage unit of a next processing stage which correspond to shifted storage locations.

One may be able to multiply a number by 3 by shifting bits in a copy of its representation to double the value of the copy, followed addition of the shifted copy to the original representation of the number. If shifting has lower cost than addition, this technique for multiplication by 3 may have lower cost than the technique described above.

Another tool that enables low-cost multiplication is negation. In signed binary representations, there is a bit which indicates whether a number is positive or negative. Multiplication by −1 can be implemented by flipping the value of this sign bit. Similarly, negation of a number in a binary twos complement representation can be implemented by flipping all the bits of the representation and adding a constant to the result.

Low-cost operations such as addition, shifting, and element-changing (bit-flipping, in the case of binary storage elements) enable low-cost multiplication for particular number values in particular finite-precision numeric formats. The lowest-cost implementations for individual product computation are constant multipliers in which all control and operational steps necessary in a non-constant multiplier have been eliminated.

Constant multipliers have been proposed for implementing transforms such as discrete Fourier transforms and discrete cosine transforms. For useful transform sizes, these transforms use a large number of multiplication operations. In applications, the transforms are often computed repeatedly. Also, and most importantly, the transforms have fixed weights that are known in advance.

The cost of a particular constant multiplier may depend on the number value of the constant, the representation of the constant, and the finite-precision numeric format of the representation. However, the use of a constant multiplier does not require a particular number value or finite-precision numeric format, only that one of the two numbers being multiplied is the constant. The transforms for which constant multipliers have been proposed are those which have fixed, known weights.

The concept of replacing necessary but costly steps with alternative lower-cost steps appears in the constant multipliers proposed by U.S. Pat. No. 4,868,778 issued to J. E. Disbrow on Sep. 19, 1989 and by U.S. Pat. No. 5,841,684 issued to K. Dockser on Nov. 24, 1998. Analogous to the technique discussed above for multiplying a number by 3 using a shift operation and an addition operation instead of two addition operations, these patents propose computation of a partial product, shifting of that partial product, and addition. This saves addition operations when there are repeated patterns in a particular representation of a constant. The partial products are intermediate terms which are used in computing the desired final product.

The reduced-complexity multiplication techniques described above rely on either the special properties of number values, on special properties of number representations in particular finite-precision numeric formats, or on both. They consider multiplication of one number by another number. However, they do not take into account the fact that in a signal processing transform, one or more numbers may each appear in several different products.

### Description—Fast Fourier Transform Techniques

There are many techniques for computation of the DFT and inverse DFT which reduce the number of multiplication operations required. These techniques are known as fast Fourier transform, or FFT, techniques. As mentioned above, computation of an N-point DFT or inverse DFT directly from equation (1) requires approximately O(N²) complex multiplications. FFT techniques can obtain a reduction to approximately O(N log N) for certain values of N. For large N, the complexity of FFT techniques is much less than the complexity of direct techniques.

One special property of discrete Fourier transform weights is that they are uniformly spaced on the unit circle in the complex plane. Multiplication of one weight by a unit-amplitude complex number with a phase equal to the uniform phase spacing results in another valid weight. Because of the special properties of the weights, for suitable values of the transform size N, it is possible to decompose a DFT computation into a set of DFT computations of smaller size. Accordingly, it may be possible to decompose each small DFT computation into a set of even smaller DFT computations.

When it is recursively applied, the decomposition leads to a computational structure consisting of successive stages. Each stage consists of multiple small transforms which calculate sums of products. Each small transform has multiple inputs and multiple outputs. Each output of one processing stage is passed to more than one of the small transforms of the next stage. This means that the small transforms of one stage share the calculation results of the prior stage.

The decomposition and implicit shared computation allow FFT techniques to reduce the number of multiplication operations relative to the number required for direct DFT computation. Since the multiplication count is reduced, the cost of implementing the transform may also be reduced. Subsequent to the decomposition and the resulting reduction in the number of multiplication operations, one may apply the reduced-complexity multiplication techniques discussed above. Constant or non-constant multipliers can replace general multipliers, and so reduce the cost still further.

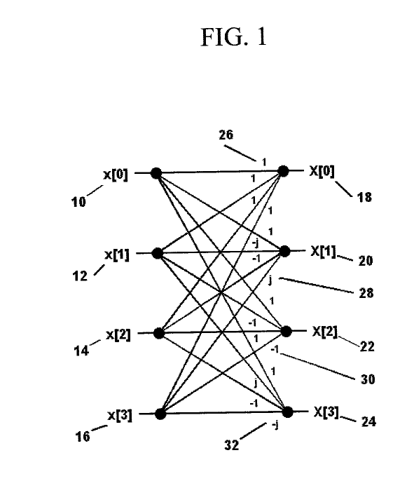

### Description—FIG. 1

For instance, the ultimate decomposition of a particular value of N may result in a set of two-point or four-point DFT computations. However, both two-point and four-point DFT computations can have extremely low implementation cost.

FIG. 1 shows a structure for computing a 4-point discrete Fourier transform. In the figure there are a DFT input x[0] 10, a DFT input x[1] 12, a DFT input x[2] 14, and a DFT input x[3] 16. The transform produces a DFT output X[0] 18, a DFT output X[1] 20, a DFT output X[2] 22, and a DFT output X[3] 24. Each output is the sum of several inputs each weighted by a coefficient. The possible weights for a 4-point DFT are a DFT weight 1+0j 26, a DFT weight 0+j 28, a DFT weight −1+0j 30, and a DFT weight 0−j 32. In the figure the weight of each input in each output is displayed next to the connecting branch between the two.

Suppose there is an arbitrary complex number with real component A and imaginary component B, for instance, an input of the 4-point DFT in FIG. 1.

(A+Bj)(1+0j)=A+Bj (2)

(A+Bj)(−1+0j)=−A−Bj (3)

(A+Bj)(0+1j)=−B+Aj (4)

(A+Bj)(0−j)=B−Aj (5)

Equations (2), (3), (4), and (5) show that the products of A+Bj and the four possible weights of the transform in FIG. 1 require only negation operations and operations that exchange the real and imaginary components of the arbitrary complex number. Suitable sets of these operations can replace the general real multipliers that would be used in a general complex multiplier in the transform of FIG. 1.

The four-point DFT of FIG. 1 can be computed with general multipliers. However, it can have much lower cost when negation and exchange operations replace general multipliers, if those operations have low cost. The potential for reduced cost depends on the special number values of the transform weights and on the low-cost substitute operations.

### Description—FFT and Reduced-Complexity Multiplier Summary

FFT techniques can reduce the cost of implementing a DFT or an inverse DFT in two ways. One way is by decomposing a large transform into sets of small transforms. This reduces the number of multiplications required to compute the large transform relative to the number of multiplications required for direct computation. A key feature of this cost reduction is that it depends on the special properties of number values of the DFT or inverse DFT weights. It does not depend on the actual representations of the weights. For instance, the multiplication count savings are the same whether the weights are represented in a 16-bit binary twos complement or in a 24-bit signed integer format.

The second way that FFT techniques can reduce the cost of implementing a DFT or an inverse DFT is by using low-complexity multiplication techniques. These can be existing techniques such as the negation and exchange methods discussed above for FIG. 1. They can also be constant multiplier techniques, or non-constant, non-general multiplier techniques. The actual cost of low-complexity multiplication techniques can vary. Key features of the cost reduction can be the number values of the numbers being multiplied, the finite-precision numeric formats in which they are represented, and their actual representations in those formats.

Prior art reduced-complexity multiplication techniques have focused on exploiting number values and representations when computing products one at a time. FFT techniques using implicit shared computation have relied on properties of weight values that are independent of finite-precision numeric format.

In many signal processing transforms, a number may appear in several products. The weights of the number in each product may be known constants, or may vary. Even if there are no convenient special relationships among the number values of the weights, it is entirely possible that the representations of those number values in particular finite-precision numeric formats have common properties that allow shared calculations when computing products.

### Description—The Preferred Embodiment

The preferred embodiment of the present invention is a machine used in computing one or more sums of products, as described in claim 1. The preferred embodiment comprises a first real number in a first finite-precision numeric format, a second real number in a second finite-precision numeric format, and a third number in a third finite-precision numeric format.

The preferred embodiment has first real multiplier means for computing a first product equal to the product of the first real number and the second real number, as well as a set of intermediate terms. The preferred embodiment has second real multiplier means for computing a second product equal to the product of the first real number and the third real number. In computing the second product, the second real multiplier means uses one or more members of the set consisting of the first product and the first set of intermediate terms.

Because at least one computation result of the first real multiplier means is available to and used by the second real multiplier means, the preferred embodiment of the invention can lead to a lower cost of computing both products than would be possible if each product were computed separately.

In some ways, the invention is similar to the constant multiplier technique of U.S. Pat. Nos. 4,868,778 and 5,841,684. However, in each of those inventions, calculation results are shared within a multiplier that computes a single product of two numbers. In the present invention, at least one calculation result is shared between computation of different products.

The present invention is also similar in some ways to FFT techniques based on decomposition of large transforms into sets of smaller transforms. However, those FFT techniques rely on very specific relations between the number values of the transform weights. Likewise, fast techniques for other transforms such as the discrete cosine transform rely on particular relationships between the number values of transform weights.

In contrast to FFT and other fast techniques, the present invention does not require a signal processing transform having weights with particular relations among their number values. The present invention can exploit number values, but it can also exploit representations of number values in particular finite-precision numeric formats. The preferred embodiment, for instance, can exploit properties of the number values and representations of the second real number and the third real number to achieve low-complexity implementation of the multipliers.

The second real number and the third real number do not have to have the same finite-precision numeric format, although they could. For instance, the second real number might have a representation in a 16-bit twos complement format, while the third real number might have a representation in a 24-bit twos complement format. These finite-precision numeric formats are different, but the two number representations may have common patterns of bits.

The preferred embodiment of the invention according to claim 1 includes first real multiplier means and second real multiplier means. The invention can be applied to complex multiplication with complex numbers represented as pairs of real numbers. For instance, the real numbers in claim 1 could be real or imaginary components of complex numbers represented in Cartesian coordinates.

### Description—Claim 2 and Claim 3

An alternative embodiment of the invention described in dependent machine claim 2 requires that the second real multiplier means of claim 1 not be able to compute the product of the first real number and the second real number. Another alternative embodiment of the invention described in claim 3 requires that the first real multiplier means not be able to compute the product of the first real number and the third real number.

The alternative embodiments of claims 2 and 3 reinforce that neither the first real multiplier means nor the second real multiplier means are required to be general multiplier means. One or both could be constant multipliers or non-constant, non-general multipliers. Multipliers that cannot compute the same products can share calculation results.

The invention could be applied to discrete Fourier transform computation after a fast Fourier transform technique has reduced the multiplication count from O(N²) to O(N log N) and after constant multipliers have been selected in order to reduce the cost of each multiplication. Suitable groups of two or more constant multipliers could share calculation results, thereby reducing the cost of computing the DFT below that of the FFT technique with separate constant multipliers.

### Description—Claim 4

Dependent machine claim 4 requires that the second real multiplier means of claim 1 not use the first product in computing the second product. The second real multiplier means uses at least one member of the set of intermediate terms, however.

Dependent machine claim 4 is intended to cover parallel implementation of the multipliers. In a parallel implementation, the first product and the second product are computed simultaneously. While the first real multiplier means uses the intermediate terms to compute a final result which is the first product, the second real multiplier means can use the intermediate terms to compute a final result which is the second product. The intermediate terms can be computed once, and then shared.

### Description—Claim 5 and Claim 6

Dependent machine claim 5 restricts the machine of claim 1 by including additive means for adding the first product and the second product to a first product sum. The first product sum is not a desired product of two numbers. This means that the first product sum cannot be an implementation of a multiplier in which partial product computations are shared, thus reducing the cost of the multiplication. It is intended that claim 5 highlight the differences between the present invention and prior art multipliers such as those of U.S. Pat. Nos. 4,868,778 and 5,841,684, which share computations in computing one product and which do not share computations in computing more than one product.

Dependent machine claim 6 restricts the machine of claim 1 by further including first additive means for adding the first product to a first product sum and second additive means for adding the second product to a second product sum. The first product sum and the second product sum are separate product sums.

Dependent machine claim 6 reinforces the idea that the shared computation of the machine of claim 1 can be used to compute different products that contribute to separate product sums. For instance, the invention can be used to compute the contribution of one transform input to a first transform output that is a sum of weighted inputs and to compute the contribution of that same transform input to a second, separate transform output that is also a sum of weighted inputs.

For the product sums to be separate, there should be at least one sum of products to which the first product sum contributes and to which the second product sum does not, or else at least one sum of products to which the second product sum contributes and to which the first product sum does not.

### Description—Claim 7 and Claim 8

Independent machine claim 7 covers an embodiment of the invention in which computations are shared in computing two products using a multiple-output multiplier. This embodiment of the invention comprises a first number in a first finite-precision numeric format, a second number in a second finite-precision numeric format, and a third number in a third finite-precision numeric format. The embodiment also comprises multiplier means for computing a first product and a second product. The first product is equal to the product of the first number and the second number. The second product is equal to the product of the first number and the third number.

The multiplier means of claim 7 uses at least one calculation result in computing the first product and also in computing the second product. Thus, while it may be treated as a single multiplier means capable of computing more than one output, the machine of claim 7 uses the same concept of sharing calculation results between two different product computations that is a key feature of embodiments using more than one multiplier.

Dependent machine claim 8 restricts machine claim 7 by requiring that the second product not equal the product of the first number and the complex conjugate of the second number except when the first number is zero or the second number is equal to the complex conjugate of the third number. Also, the second product is not equal to the product of the second number and the complex conjugate of the first number except when the first number is zero or the first number is real and the second number is equal to the third number.

The restrictions imposed in claim 8 on the products of claim 7 are intended to emphasize that a multiple-output multiplier with shared computation is not limited to computing a first product which is the product of two complex numbers and a second product which is the product of one of the complex numbers and the complex conjugate of the other complex number. Other complex number values may allow sharing of computation. Also, particular representations of other complex number values in particular finite-precision numeric formats may allow sharing of computation.

### Description—Claims 9 Through 16

Claims 9 through 16 are method claims which are analogous to machine claims 1 through 8. Method claims 9 through 16 are discussed briefly below.

Independent method claim 9 is a method used in computing one or more sums of products where at least one of the sums is not a desired product of two numbers. The method of claim 9 comprises first real multiplication of a first real number by a second real number and second real multiplication of the first real number by a third real number. The first real number is in a first finite-precision numeric format, the second real number is in a second finite-precision numeric format, and the third real number is in a third finite-precision numeric format.

The method of the first real multiplication produces a first product and a first set of intermediate terms. The method of the second real multiplication produces a second product, and uses at least one of the terms computed in the first real multiplication.

Dependent method claim 10 requires that the method of the second real multiplication of claim 9 not be able to compute the product of the first real number and the second real number. Dependent method claim 11 requires that the method of the first real multiplication of claim 9 not be able to compute the product of the first real number and the third real number. Claims 10 and 11 are intended to cover shared multiplication when one or both of the multipliers are not general multipliers.

Dependent method claim 12 requires that the method of the second real multiplication of claim 9 not use the product of the first real number and the second real number that is calculated by the first real multiplication method. This means that the method of the second real multiplication must use at least one member of the first set of intermediate terms. Claim 12 is intended to cover methods for parallel computation of the two products.

Dependent method claim 13 restricts method claim 9 by further including addition of the first product and the second product to a first product sum which is not a desired product of two numbers.

Dependent method claim 14 restricts method claim 9 by further including addition of the first product to a first product sum and second addition of the second product to a second product sum. The two product sums are separate. The method of this embodiment of the invention covers shared multiplication in signal processing transforms such as computing the contribution of one transform input to two separate transform outputs.

Independent method claim 15 comprises multiplication to produce a first product and a second product. The first product is the product of a first number and a second number. The third product is the product of the first number and a third number. The first number is represented in a first finite-precision numeric format. The second number is represented in a second finite-precision numeric format. The third number is represented in a third finite-precision numeric format. The multiplication method uses at least one of the calculation results used in computing the first product for computing the second product as well.

Dependent method claim 16 restricts method claim 15 by requiring that the second product not equal the product of the first number and the complex conjugate of the second number except when the first number is zero or the second number is equal to the complex conjugate of the third number. Also, the second product is not equal to the product of the second number and the complex conjugate of the first number except when the first number is zero or the first number is real and the second number is equal to the third number.

The restrictions imposed in claim 16 on the products of claim 15 are intended to emphasize that a multiple-output multiplication method with shared computation is not limited to computing a first product which is the product of two complex numbers and a second product which is the product of one of the complex numbers and the complex conjugate of the other complex number. Other complex number values may allow sharing of computation. Also, particular representations of other complex number values in particular finite-precision numeric formats may allow sharing of computation.

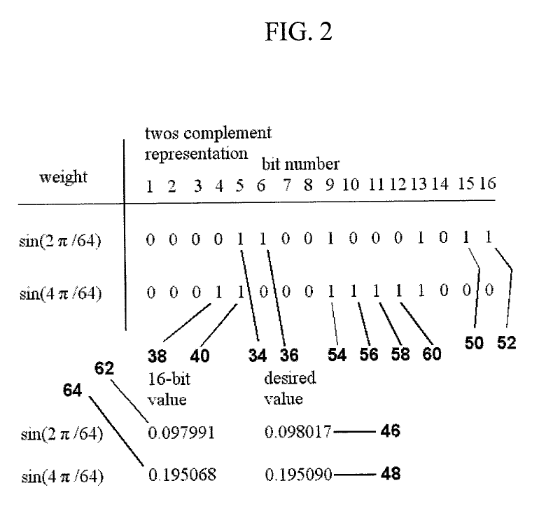

### Description—FIG. 2

Thus far the present invention has been discussed in terms of multipliers or multiplication of numbers in finite-precision numeric formats. Below is a specific example of two number values and their representations in a finite-precision numeric format. The discussion clarifies how a representation of one number can have common properties with a representation of another number.

In digital signal processing, every number is stored in a finite-precision numeric format. The format is defined by a finite number of representation elements and a mapping between numbers and representation element values. While it is possible to have multiple types of representation elements, it is common to use one type of representation element, in particular binary representation elements, or bits, which can take on two possible values. Common binary mappings include signed integer, unsigned integer, floating point, and twos complement, among others.

FIG. 2 shows the 16-bit twos complement representations of sin(2 π/32) and sin(2 π/64), two numbers which are possible weights used in computing a discrete Fourier transform. There are six non-zero bits in the 16-bit twos complement representation of sin(2 π/64), including a fifth bit of sin(2 π/64) 34, a sixth bit of sin(2 π/64) 36, a fifteenth bit of sin(2 π/64) 50, and a sixteenth bit of sin(2 π/64) 52. The 16-bit decimal value of sin(2 π/64) 62 is 0.097991 to six decimal places. The desired decimal value of sin(2 π/64) 46 is 0.098017.

There are seven non-zero bits in the 16-bit twos complement representation of sin(4 π/64). Among these are a fourth bit of sin(4 π/64) 38, a fifth bit of sin(4 π/64) 40, a ninth bit of sin(4 π/64) 54, a tenth bit of sin(4 π/64) 56, an eleventh bit of sin(4 π/64) 58, and a twelfth bit of sin(4 π/64) 60. The 16-bit decimal value of sin(4 π/64) 64 is 0.195068 to six decimal places. The desired decimal value of sin(4 π/64) 48 is 0.195090 to six decimal places. With more bits, or higher precision, the actual value more closely matches the desired value.

Consider multiplying the 16-bit twos complement representation sin(2 π/64) by an arbitrary number. One might first compute a first partial product consisting of the contribution to the product of fifteenth bit of sin(2 π/64) 50 and sixteenth bit of sin(2 π/64) 52 multiplied by the arbitrary number. These two bits are adjacent bits that each have value 1. Fifth bit of sin(2 π/64) 34 and sixth bit of sin(2 π/64) 36 are also two adjacent bits that each have a value 1. As an intermediate term, the first partial product could be shifted ten binary places to obtain a second partial product consisting of the contribution of fifth bit of sin(2 π/64) 34 and sixth bit of sin(2 π/64) 36 to the product of this representation of sin(2 π/64) and the arbitrary number. This is the idea behind shared computation in the constant multiplier techniques of U.S. Pat. Nos. 4,868,778 and 5,841,684.

Next, consider multiplying the 16-bit twos complement representation of sin(4 π/64) by the arbitrary number. In the 16-bit twos complement representation of sin(4 π/64), fourth bit of sin(4 π/64) 38 and fifth bit of sin(4 π/64) 40 are two adjacent bits that each have a value 1. Also, ninth bit of sin(4 π/64) 54 and tenth bit of sin(4 π/64) 56, and eleventh bit of sin(4 π/64) 58 and twelfth bit of sin(4 π/64) 60 are pairs of adjacent bits having value 1.

The first partial product computed for the product of the 16-bit twos complement representation of sin(2 π/64) and the arbitrary number could be shifted eleven places to obtain the contribution of fourth bit of sin(4 π/64) 38 and fifth bit of sin(4 π/64) 40 to the product of the 16-bit twos complement representation of sin(4 π/64) and the arbitrary number. Likewise, the first partial product could be shifted six places or four places to obtain the contributions of ninth bit of sin(4 π/64) 54 and tenth bit of sin(4 π/64) 56, and the contributions of eleventh bit of sin(4 π/64) 58 and twelfth bit of sin(4 π/64) 60 respectively.

In this simple example, the 16-bit twos complement representation of sin(2 π/64) corresponds to the second real number of claim 1, 16-bit twos complement representation of sin(4 π/64) corresponds to the third real number, and the arbitrary number corresponds to the first real number. The first partial product is an intermediate term computed by a multiplier calculating the product of the first real number and the second real number. The presence of adjacent pairs of bits with value 1 in the representations of both sin(2 π/64) and sin(4 π/64) means that the first partial product does not have to be re-calculated in computing the second product. It can be shared.

Note that the possibility of sharing the first partial product in the two product computations is not apparent from 16-bit decimal value of sin(2 π/64) 62 to six decimal places and 16-bit decimal value of sin(4 π/64) 64 to six decimal places, or from desired decimal value of sin(2 π/64) 46 to six places and desired decimal value of sin(4 π/64) 48 to six decimal places. Sharing of the first partial product depends on the representations of the second real number and the third real number, not just on their number values. Alternative representations of the same number values in other finite-precision numeric formats, such as signed integer or signed decimal, may offer different opportunities for shared computation.

### CONCLUSION, RAMIFICATIONS, AND SCOPE

The reader will see that the present invention has several advantages over prior art techniques for multiplication of number pairs, particularly in signal processing transforms which use sums of products. These signal processing transforms often have outputs that are sums of weighted inputs. The weights may be fixed and known in advance, or may take on a restricted set of possible values. Likewise, in some applications the inputs may come from a limited set of possible values. The invention exploits restrictions on the relationship between number values, representations, or number values and representations of two number pairs being multiplied in order to reduce the cost of implementing the multiplication operations.

In a preferred embodiment of the invention, a first multiplier computes a first product which is the product of a first real number and a second real number, as well as a first set of intermediate terms. Rather than performing an entirely independent computation, a second multiplier computes the product of the first real number and a third real number using one or more members of a set consisting of the first set of intermediate terms computed by the first multiplier and the first product. The two multipliers can exploit the relationship between a representation or number value of the second real number and a representation or number value of the third real number to decrease the cost of the computation.

In an alternative embodiment of the invention, the second multiplier is not able to compute the product of the first real number and the second real number. In another alternative embodiment of the invention, the first multiplier is not able to compute the product of the first real number and the third real number. In these embodiments, reduced-complexity multipliers such as constant multipliers or the non-general, non-constant multipliers discussed in the application NON-CONSTANT REDUCED-COMPLEXITY MULTIPLICATION FOR SIGNAL PROCESSING TRANSFORMS by the inventor of the present invention can be used.

In an alternative embodiment of the invention, the second multiplier uses members of the set of intermediate terms generated by the first multiplier, but not the first product. This embodiment allows for parallel implementation of the first multiplier and the second multiplier.

The invention is used in computing sums of products. It is particularly useful in transforms with fixed weights, especially when the transform is used repeatedly in a signal processing application. The numbers can be Cartesian components of complex numbers. Alternative embodiments of the invention include a number to be multiplied that is a Cartesian component of a discrete Fourier transform weight or of a discrete Fourier transform input. Alternative embodiments of the invention include a number to be multiplied that is a Cartesian component of an inverse discrete Fourier transform weight or of an inverse discrete Fourier transform input. Still another alternative embodiment of the invention includes restrictions on the allowed values of both numbers being multiplied, which may enable even greater reduction of computational complexity.

The invention can be used in computing discrete cosine transforms, discrete sine transforms, inverse discrete cosine transforms, inverse discrete sine transforms, and other transforms. The invention can be used for digital filtering. The invention can be used for pulse-shaping in digital communications, or for digital modulation.

The invention is not limited to particular number representations or to particular applications. Signal processing transforms that use multiple sums of products are used in digital communications, radar, sonar, astronomy, geology, control systems, image processing, and video processing. Technologies used to implement signal processing transforms include hardware technologies such as application specific integrated circuits and field-programmable gate arrays and software technologies such as multiplication on a general-purpose microprocessor.

The invention can be used as part of a circuit or software instruction sequence design library. The invention can be included as part of a computer program that automatically generates efficient machines and methods for hardware circuitry and software instruction sequences.

An alternative embodiment of the invention has two or more multipliers with one or more multipliers using intermediate terms computed by one or more other multipliers. Several multipliers can compute intermediate terms to be shared with several other multipliers. Still another alternative embodiment of the invention has a multiplier capable of computing multiple outputs with shared computation of two or more outputs.

The description above contains many specific details relating to finite-precision numeric formats, representation elements, number values, computational complexity measures, discrete Fourier transforms, discrete cosine transforms, discrete sine transforms, inverse transforms, FFT techniques, hardware technologies, software technologies, and signal processing applications. These should not be construed as limiting the scope of the invention, but as illustrating some of the presently preferred embodiments of the invention. The scope of the invention should be determined by the appended claims and their legal equivalents, rather than by the examples given.

I claim:

1. A machine used in computing one or more sums of products wherein at least one of said sums of products is not a desired product of two numbers, comprising:
a. a first real number represented in a first finite-precision numeric format
b. a second real number represented in a second finite-precision numeric format
c. a third real number represented in a third finite-precision numeric format
d. first real multiplier means for computing a first set of intermediate terms and a first product, said first product being the product of said first real number and said second real number
e. second real multiplier means for computing a second product, said second product being the product of said first real number and said third real number and said second real multiplier means using one or more members of the set consisting of said first product and said first set of intermediate terms
whereby said first real multiplier means and said second real multiplier means share computation and can have lower implementation cost than if said first product and said second product were computed separately.

2. The machine of claim 1 wherein said second real multiplier means cannot compute the product of said first real number and said second real number, whereby said second real multiplier means can have lower implementation cost than if it must also be able to compute the product of said first real number and said second real number.

3. The machine of claim 1 wherein said first real multiplier means cannot compute the product of said first real number and said third real number, whereby the first real multiplier means can have lower implementation cost than if it must also be able to compute the product of said first real number and said third real number.

4. The machine of claim 1 wherein said second real multiplier means does not use said first product, whereby said first product and said second product may be computed in a parallel manner.

5. The machine of claim 1 further including additive means for adding said first product and said second product to a first product sum, where said first product sum is not a desired product of two numbers, whereby said first product, said second product, and said first product sum may be computed with lower cost than if each is computed separately.

6. The machine of claim 1 further including first additive means for adding said first product to a first product sum and second additive means for adding said second product to a second product sum, where said first product sum and said second product sum are separate product sums such that one or both of the following properties hold:
a. there is at least one sum of products to which said first product sum contributes and to which said second product sum does not contribute
b. there is at least one sum of products to which said second product sum contributes and to which said first product sum does not contribute
whereby said machine of claim 1 can be used for computing and adding the contribution of said first real number to two separate outputs of a signal processing transform.

7. A machine used in computing one or more sums of products wherein at least one of said sums of products is not a desired product of two numbers, comprising:
a. a first number in a first finite-precision numeric format
b. a second number in a second finite-precision numeric format
c. a third number in a third finite-precision numeric format
d. multiplier means for computing a first product equal to the product of said first number and said second number and for computing a second product equal to the product of said first number and said second number, where at least one of the calculation results used in computing said first product is also used in computing said second product
whereby said multiplier means computes at least two products using at least one shared calculation result.

8. The machine of claim 7, in which:
a. said second product is not equal to the product of said first number and the complex conjugate of said second number except in the following cases:
i. said second number is equal to the complex conjugate of said third number
ii. said first number is zero
b. said second product is not equal to the product of said second number and the complex conjugate of said first number except in the following cases:
i. said first number is real, and said second number is equal to said third number
ii. said first number is zero
whereby said multiplier means is not a multiple-output multiplier which computes the product of two numbers and the product of two numbers with one of the numbers conjugated.

9. A method used in computing one or more sums of products wherein at least one of said sums of products is not a desired product of two numbers, comprising:
a. first real multiplication of a first real number represented in a first finite-precision numeric format by a second real number represented in a second finite-precision numeric format, producing:
i. a first product equal to the product of said first real number and said second real number
ii. a first set of intermediate terms
b. second real multiplication of said first real number by a third real number represented in a third finite-precision numeric format, producing a second product equal to the product of said first real number and said third real number using at least one member of the set consisting of said first product and said first set of intermediate terms
whereby said first real multiplication and said second real multiplication share computation and can have lower implementation cost than if said first product and said second product were computed separately.

10. The method of claim 9 wherein the method of said second real multiplication cannot compute the product of said first real number and said second real number, whereby the method of said second real multiplication can have lower implementation cost than if it must also be able to compute the product of said first real number and said second real number.

11. The machine of claim 9 wherein the method of said first real multiplication cannot compute the product of said first real number and said third real number, whereby the method of said first real multiplication can have lower implementation cost than if it must also be able to compute the product of said first real number and said third real number.

12. The method of claim 9 wherein the method of said second real multiplication does not use said first product, whereby said first product and said second product may be computed in a parallel manner.

13. The method of claim 9 further including addition of said first product and said second product to a first product sum, where said first product sum is not a desired product of two numbers, whereby said first product, said second product, and said first product sum may be computed with lower cost than if each is computed separately.

14. The method of claim 9 further including first addition of said first product to a first product sum and second addition of said second product to a second product sum, where said first product sum and said second product sum are separate product sums, sums such that one or both of the following properties hold:
a. there is at least one sum of products to which said first product sum contributes and to which said second product sum does not contribute
b. there is at least one sum of products to which said second product sum contributes and to which said first product sum does not contribute
whereby said method of claim 9 can be used for computing and adding the contribution of said first real number to two separate outputs of a signal processing transform.

15. A method used in computing one or more sums of products wherein at least one of said sums of products is not a desired product of two numbers, comprising multiplication to produce a first product and a second product, where:
a. said first product is equal to the product of a first number in a first finite-precision numeric format by a second number in a second finite-precision numeric format
b. said second product is equal to the product of said first number and a third number in a third finite-precision numeric format
c. at least one of the calculation results used in computing said first product is also used in computing said second product
whereby the method of said multiplication computes at least two products using at least one shared calculation result.

16. The method of claim 15, in which:
a. said second product is not equal to the product of said first number and the complex conjugate of said second number except in the following cases:
i. said second number is equal to the complex conjugate of said third number
ii. said first number is zero
b. said second product is not equal to the product of said second number and the complex conjugate of said first number except in the following cases:
i. said first number is real, and said second number is equal to said third number
ii. said first number is zero
whereby said multiplication is not a multiple-output multiplication method which computes the product of two numbers and the product of two numbers with one of the numbers conjugated.
